(19) United States
(12) Patent Application Publication
(10) Pub. No.: US 2024/0338464 A1
(43) Pub. Date: Oct. 10, 2024

(54) SECURE COMMUNICATION BETWEEN A CLIENT COMPUTER AND A REMOTE COMPUTER

(71) Applicant: KAZUAR ADVANCED TECHNOLOGIES LTD., Tel-Aviv (IL)

(72) Inventors: Yaacov FENSTER, Petach Tikvah (IL); Michael David STRAUSS, Tel Aviv (IL); Daniel Mondy FINCHELSTEIN, Rishon Lezion (IL); Yuval Moshe PORAT, Tel Aviv-Yafo (IL)

(21) Appl. No.: 18/575,144

(22) PCT Filed: Jun. 23, 2022
(86) PCT No.: PCT/IL2022/050677

§ 371 Date: Dec. 28, 2023

(30) Foreign Application Priority Data
Jun. 29, 2021 (IL) 284485

(51) Int. Cl. G06F 21/60; G06F 21/82

(52) U.S. Cl. CPC G06F 21/606; G06F 21/602; G06F 21/82

(57) ABSTRACT

There are provided various of methods and systems of secure communication between a client computer and a remote computer. One method provides an engine computer operatively connected to the client computer and the remote computer, and configured to accommodate a remote connection (RC) client, while the remote computer is configured to accommodate a RC server. The engine computer is configured to, upon receiving encrypted input data from the client computer, decrypt the encrypted input data into input data, inject the input data to the RC client, and transmit by the RC client to the RC server the input data to be processed by the remote computer to generate output data. The engine computer is further configured to receive, by the RC client from the RC server, the output data, transmit the output data to the output peripheral component through a second secured end-to-end communication channel established there between.

### TECHNICAL FIELD

The presently disclosed subject matter relates, in general, to the field of remote communication, and more specifically, to secure communication between two remote entities.

### BACKGROUND

Nowadays there is an ever-increasing need for organizations to shift to a remote working environment and enable their employees to be able to work remotely. Remote work often requires accessing key resources that are kept on the office network, which makes it essential to establish a remote connection from a local computer to a remote work computer. Organizations face the challenge of how to provide remote workforces with secure access to corporate systems, applications, and data on a corporate network.

This, together with the ever-increasing usage of cloud-based services, has increased the challenge of client computers (such as, e.g. remote desktop, laptop, cellular phone and so forth) operating vis-à-vis a remote server (which may reside in the cloud) for achieving a secure and seamless connection.

On the other hand, information security violation and attacks on computer devices and computer networks keep rising at an alarming rate, with increased sophistication, causing undesired data breaches and potential risks/damages to organizational and personal assets.

Certain security techniques and measures are currently used, such as, e.g., installing antivirus software, use of firewalls, establishment of data protection policies, etc. However, in order to reduce or eliminate compromising of such remote connection, there is still a need for secure data communication for ensuring and preserving data security and integrity.

### General Description

In accordance with certain aspects of the presently disclosed subject matter, there is provided computerized method of secure communication between a client computer and a remote computer, the method comprising: providing an engine computer operatively connected to the client computer and to the remote computer, wherein the engine computer is configured to accommodate a remote connection (RC) client, the remote computer is configured to accommodate a RC server, and wherein the RC client and the RC server are configured to communicate with each other using a RC protocol; upon receiving, by the engine computer, encrypted input data from the client computer, decrypting the encrypted input data into input data, injecting the input data to the RC client, and transmitting by the RC client to the RC server the input data to be processed by the remote computer to generate output data, wherein the client computer includes at least an input peripheral component and an output peripheral component, and wherein the encrypted input data is generated based on the input data received by the input peripheral component from an input device, and transmitted from the input peripheral component to the engine computer through a first secured end-to-end communication channel established there between by encrypting the input data using a first communication key; and upon receiving, by the RC client from the RC server, the output data, transmitting the output data from the engine computer to the output peripheral component through a second secured end-to-end communication channel established there between including encrypting the output data using a second communication key; thereby enabling the output peripheral component to decrypt the encrypted output data into the output data and render the output data at an output device.

In accordance with certain aspects of the presently disclosed subject matter, there is provided a computerized method of secure communication between a client computer and a remote computer, the method comprising: providing a client computer configured to communicate with a remote computer, the client computer including at least an input peripheral component and an output peripheral component, wherein an engine computer is operatively connected to the client computer and to the remote computer, the engine computer configured to accommodate a remote connection (RC) client, the remote computer configured to accommodate a RC server, and wherein the RC client and the RC server are configured to communicate with each other under a RC protocol; upon receiving, by the input peripheral component, input data from an input device, transmitting the input data to the engine computer through a first secured end-to-end communication channel established between the input peripheral component and the engine computer, including encrypting the input data using first a communication key; thereby enabling the engine computer to decrypt the encrypted input data using the first communication key, inject the input data to the RC client, and transmit the input data from the RC client to the RC server to be processed by the remote computer to generate output data; and further receive the output data by the RC client from the RC server, transmit the output data from the engine computer to the output peripheral component through a second secured end-to-end communication channel established therebetween by encrypting the output data using a second communication key; and upon receiving, by the output peripheral component, the encrypted output data from the engine computer, decrypting the encrypted output data into the output data which is rendered at an output device.

In accordance with certain aspects of the presently disclosed subject matter, there is provided a computerized method of secure communication between a client computer and a remote computer, the method comprising: providing a client computer configured to communicate with a remote computer, the client computer including at least an input peripheral component and an output peripheral component; providing an engine computer operatively connected to the client computer and to the remote computer, the engine computer configured to accommodate a remote connection (RC) client, the remote computer configured to accommodate a RC server, and wherein the RC client and the RC server are configured to communicate with each other using a RC protocol; upon receiving, by the input peripheral component, input data from an input device, transmitting the input data to the engine computer through a first secured end-to-end communication channel established between the input peripheral component and the engine computer, including encrypting the input data using first a communication key; decrypting, by the engine computer, the encrypted input data using the first communication key, injecting the input data to the RC client, and transmitting the input data from the RC client to the RC server to be processed by the remote computer to generate output data; and receiving, by the RC client of the engine computer, the output data from the RC server, transmitting the output data from the engine computer to the output peripheral component through a second secured end-to-end communication channel established therebetween by encrypting the output data using a second communication key; and receiving, by the output peripheral component, the encrypted output data from the engine computer, and decrypting the encrypted output data into the output data which is rendered at an output device.

In addition to the above features, the methods according to these aspects of the presently disclosed subject matter can comprise one or more of features (i) to (x) listed below, in any desired combination or permutation which is technically possible:
(i). The RC protocol is Virtual desktop infrastructure (VDI) protocol or a Remote Desktop Protocol (RDP).
(ii). The engine computer is integrated as a part of the remote computer.
(iii). The first and second secured end-to-end communication channel are each established by performing a two-way authentication, and creating a communication key usable for encryption.
(iv). The first and second secured end-to-end communication channels are each encapsulated in a virtual private network (VPN) which is set up between the operating system of the client computer and the engine computer.
(v). The RC client and the RC server communicate with each other via a virtual private network (VPN).
(vi). The client computer works in a secure mode. The client computer is configured to switch between the secure mode and an open mode upon a switching condition being met.
(vii). The switching condition is selected from a group comprising: automatic switch per predetermined time interval, and manual switch by a user.
(viii). The methods further comprise: in response to the client computer switching from the secure mode to the open mode, upon receiving, by the input peripheral component, input data from an input device, transmit the input data to a processor of the client computer to be processed to generate output data, and transmit the output data by the processor to the output peripheral component for rendering at the output device.
(ix). The input peripheral component further comprises a demultiplexer configured to enable the switching between the secure mode and the open mode.
(x). The input peripheral component is a secure keyboard component configured to encrypt keystroke data received from a keyboard, and the output peripheral component is a secure display component configured to decrypt encrypted output data received from the engine computer to render for display at a display device.

In accordance with other aspects of the presently disclosed subject matter, there is also provided an engine computer operatively connected to a client computer and to a remote computer and configured to enable secure communication between the client computer and the remote computer, the engine computer comprising a processor and memory unit (PMU) configured to: upon receiving encrypted input data from the client computer, decrypt the encrypted input data into input data, injecting the input data to a remote connection (RC) client comprised in the PMU, and transmit by the RC client to a RC server accommodated in the remote computer, the input data to be processed by the remote computer to generate output data, wherein the RC client and the RC server are configured to communicate with each other under a RC protocol, and wherein the client computer includes at least an input peripheral component and an output peripheral component, and wherein the encrypted input data is generated based on the input data received by the input peripheral component from an input device, and transmitted from the input peripheral component to the engine computer through a first secured end-to-end communication channel established there between by encrypting the input data using a first communication key; and upon receiving, by the RC client from the RC server, the output data, transmit the output data from the engine computer to the output peripheral component through a second secured end-to-end communication channel established there between including encrypting the output data using a second communication key; wherein upon being received by the output peripheral component, the encrypted output data is decrypted into the output data which is rendered at an output device.

In accordance with other aspects of the presently disclosed subject matter, there is also provided a client computer configured to securely communicate with a remote computer, the client computer comprising: an input peripheral component comprising a processor and memory unit (PMU) configured to: receive input data from an input device, transmit the input data to an engine computer through a first secured end-to-end communication channel established between the input peripheral component and the engine computer, including encrypting the input data using a first communication key, wherein an engine computer is operatively connected to the client computer and to the remote computer, the engine computer configured to accommodate a remote connection (RC) client, the remote computer configured to accommodate a RC server, and wherein the RC client and the RC server are configured to communicate with each other under a RC protocol; thereby enabling the engine computer to decrypt the encrypted input data using the first communication key, inject the input data to the RC client, and transmit the input data from the RC client to the RC server to be processed by the remote computer to generate output data; and further receive the output data by the RC client from the RC server, transmit the output data from the engine computer to the output peripheral component through a second secured end-to-end communication channel established therebetween by encrypting the output data using a second communication key; and an output peripheral component comprising a processor and memory unit (PMU) configured to: receive the encrypted output data from the engine computer, and decrypt the encrypted output data into the output data which is rendered at an output device.

In accordance with other aspects of the presently disclosed subject matter, there is also provided a computerized system of secure communication between a client computer and a remote computer, the system comprising: a client computer configured to communicate with a remote computer; and an engine computer operatively connected to the client computer and to the remote computer, the engine computer configured to accommodate a remote connection (RC) client, the remote computer configured to accommodate a RC server, and wherein the RC client and the RC server are configured to communicate with each other under a RC protocol; wherein the client computer comprises at least an input peripheral component and an output peripheral component, and the input peripheral component is configured to: upon receiving input data from an input device, transmit the input data to the engine computer through a first secured end-to-end communication channel established between the input peripheral component and the engine computer by encrypting the input data using a first communication key; wherein the engine computer is configured to: decrypt the encrypted input data using the first communication key, inject the input data to the RC client, and transmit the input data from the RC client to the RC server to be processed by the remote computer to generate output data; and receive, by the RC client, the output data from the RC server, transmit the output data from the engine computer to the output peripheral component through a second secured end-to-end communication channel established there between by encrypting the output data using a second communication key; and wherein the output peripheral component is configured to receive the encrypted output data from the engine computer, and decrypt the encrypted output data into the output data which is rendered at an output device.

These systems according to these aspects of the presently disclosed subject matter can comprise one or more of features (i) to (x) listed above with respect to the methods, mutatis mutandis, in any desired combination or permutation which is technically possible.

In accordance with other aspects of the presently disclosed subject matter, there is provided a non-transitory computer readable storage medium tangibly embodying a program of instructions that, when executed by a computer, cause the computer to perform one or more computerized methods for implementing or operating some or all the aspects of the methods of secure communication between a client computer and a remote computer, and this aspect of the disclosed subject matter can comprise one or more of features (i) to (x) listed above with respect to the methods, mutatis mutandis, in any desired combination or permutation which is technically possible.

In accordance with other aspects of the presently disclosed subject matter, there is provided a computerized method of secure communication between a client computer and a remote computer, the method comprising: providing a client computer configured to communicate with a remote computer, the client computer including at least an input peripheral component and an output peripheral component, wherein the output peripheral component is configured to accommodate a remote connection (RC) client, the remote computer is configured to accommodate a RC server, and wherein the RC client and the RC server are configured to communicate with each other using a RC protocol; upon receiving, by the input peripheral component, input data from an input device, transmitting the input data to the output peripheral component through a secured end-to-end communication channel established between the input peripheral component and the output peripheral component including encrypting the input data using a communication key; upon receiving, by the output peripheral component, the encrypted input data, decrypting, using the communication key to decrypt the encrypted input data into the input data, injecting the input data into the RC client, and transmitting the input data by the RC client to the RC server to be processed by the remote computer to generate output data; and receiving the generated output data by the RC client from the RC server, and rendering the output data at an output device.

In addition to the above features, the methods according to these aspects of the presently disclosed subject matter can comprise one or more of features (xi) to (xix) listed below, in any desired combination or permutation which is technically possible:
(xi). The RC protocol is Virtual desktop infrastructure (VDI) protocol or a Remote Desktop Protocol (RDP).
(xii). The RC client and the RC server communicate with each other via a virtual private network (VPN) that is set up between an operating system of the client computer and the remote computer.
(xiii). The client computer works in a secure mode. The client computer is configured to switch between the secure mode and an open mode upon a switching condition being met.
(xiv). The switching condition is selected from a group comprising: automatic switch per predetermined time interval, and manual switch by a user.
(xv). The methods further comprise: in response to the client computer switching from the secure mode to the open mode, upon receiving, by the input peripheral component, input data from an input device, transmit the input data to a processor of the client computer to be processed to generate output data, and transmit the output data by the processor to the output peripheral component for rendering at the output device.
(xvi). The input peripheral component further comprises a demultiplexer configured to enable the switching between the secure mode and the open mode.
(xvii). The input peripheral component is a secure keyboard component configured to encrypt keystroke data received from a keyboard, and the output peripheral component is a secure display component configured to decrypt encrypted output data received from the engine computer to render for display at a display device.
(xviii). A virtual private network (VPN) concentrator is operatively connected to the client computer and the remote computer, and the input data is transmitted from the RC client to the RC server under the RC protocol via a VPN that is set up between an operating system of the client computer and the VPN concentrator, and wherein the input data is further forwarded from the VPN concentrator to the RC server.
(xix). A virtual private network (VPN) decoupler is operatively connected to the client computer and the remote computer, and the input data is transmitted from the RC client to the RC server under the RC protocol via a first VPN that is set up directly between the output peripheral component of the client computer and the VPN decoupler, and subsequently via a second VPN that is set up between the VPN decoupler and the remote computer.

In accordance with other aspects of the presently disclosed subject matter, there is provided a client computer configured to securely communicate with a remote computer, the client computer comprising: an input peripheral component and an output peripheral component, wherein the output peripheral component is configured to accommodate a remote connection (RC) client, the remote computer is configured to accommodate a RC server, and wherein the RC client and the RC server are configured to communicate with each other using a RC protocol; wherein the input peripheral component comprises a processor and memory circuitry (PMC) configured to: upon receiving input data from an input device, transmit the input data to the output peripheral component through a secured end-to-end communication channel established between the input peripheral component and the output peripheral component by encrypting the input data using a communication key; wherein the output peripheral component comprises a processor and memory circuitry (PMC) configured to: upon receiving the encrypted input data, decrypt the encrypted input data into the input data using the communication key, inject the input data into the RC client, and transmit the input data by the RC client to the RC server to be processed by the remote computer to generate output data; and receive the generated output data by the RC client from the RC server, and render the output data at an output device.

The system according to these aspects of the presently disclosed subject matter can comprise one or more of features (xi) to (xix) listed above with respect to the method, mutatis mutandis, in any desired combination or permutation which is technically possible.

In accordance with other aspects of the presently disclosed subject matter, there is provided a non-transitory computer readable storage medium tangibly embodying a program of instructions that, when executed by a computer, cause the computer to perform one or more computerized methods for implementing or operating some or all the aspects of the methods of secure communication between a client computer and a remote computer, and this aspect of the disclosed subject matter can comprise one or more of features (xi) to (xix) listed above with respect to the method, mutatis mutandis, in any desired combination or permutation which is technically possible.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1A illustrates a schematic block diagram of a computerized system of engine-based secure communication between a client computer and a remote computer in accordance with certain embodiments of the presently disclosed subject matter;

FIG. 1B illustrates a schematic block diagram of an exemplified input peripheral component enabling the client computer to switch between different modes in accordance with certain embodiments of the presently disclosed subject matter;

FIG. 1C illustrates a schematic block diagram of an exemplified output peripheral component enabling the switch between different modes and providing corresponding output in accordance with certain embodiments of the presently disclosed subject matter;

FIG. 2A illustrates a schematic block diagram of another computerized system of secure communication between a client computer and a remote computer in accordance with certain embodiments of the presently disclosed subject matter;

FIG. 2B illustrates a schematic block diagram of the secure communication system as described with respect to FIG. 2A enhanced with a VPN concentrator in accordance with certain embodiments of the presently disclosed subject matter;

FIG. 2C illustrates a schematic block diagram of the secure communication system as described with respect to FIG. 2A enhanced with a VPN decoupler in accordance with certain embodiments of the presently disclosed subject matter;

FIG. 3 illustrates a generalized flowchart of engine-based secure communication between a client computer and a remote computer (from the client computer's perspective) in accordance with certain embodiments of the presently disclosed subject matter;

FIG. 4 illustrates a generalized flowchart of the engine-based secure communication between a client computer and a remote computer (from the engine computer's perspective) in accordance with certain embodiments of the presently disclosed subject matter;

FIG. 5 illustrates a generalized flowchart of the engine-based secure communication between a client computer and a remote computer (from both the client computer and the engine computer's perspective) in accordance with certain embodiments of the presently disclosed subject matter; and

FIG. 6 illustrates a generalized flowchart of secure communication between a client computer and a remote computer in accordance with certain embodiments of the presently disclosed subject matter.

### DETAILED DESCRIPTION OF EMBODIMENTS

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “providing”, “communicating”, “receiving”, “encrypting”, “decrypting”, “injecting”, “transmitting”, “using”, “enabling”, “switching”, “rendering”, “establishing”, “generating”, “performing”, “creating”, or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities including, by way of non-limiting example, the client computer, the engine computer, the remote computer, the secure communication system and parts thereof, such as the input peripheral component and the output peripheral component, as well as the processing and memory unit (PMU) and processor comprised therein as disclosed in the present application.

The terms “non-transitory memory” and “non-transitory storage medium” used herein should be expansively construed to cover any volatile or non-volatile computer memory suitable to the presently disclosed subject matter.

Embodiments of the presently disclosed subject matter are not described with reference to any particular programming language. It will be appreciated that a variety of programming languages may be used to implement the teachings of the presently disclosed subject matter as described herein.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

It is appreciated that, unless specifically stated otherwise, certain features of the presently disclosed subject matter, which are described in the context of separate embodiments, can also be provided in combination in a single embodiment. Conversely, various features of the presently disclosed subject matter, which are described in the context of a single embodiment, can also be provided separately or in any suitable sub-combination. In the following detailed description, numerous specific details are set forth in order to provide a thorough understanding of the methods and apparatus.

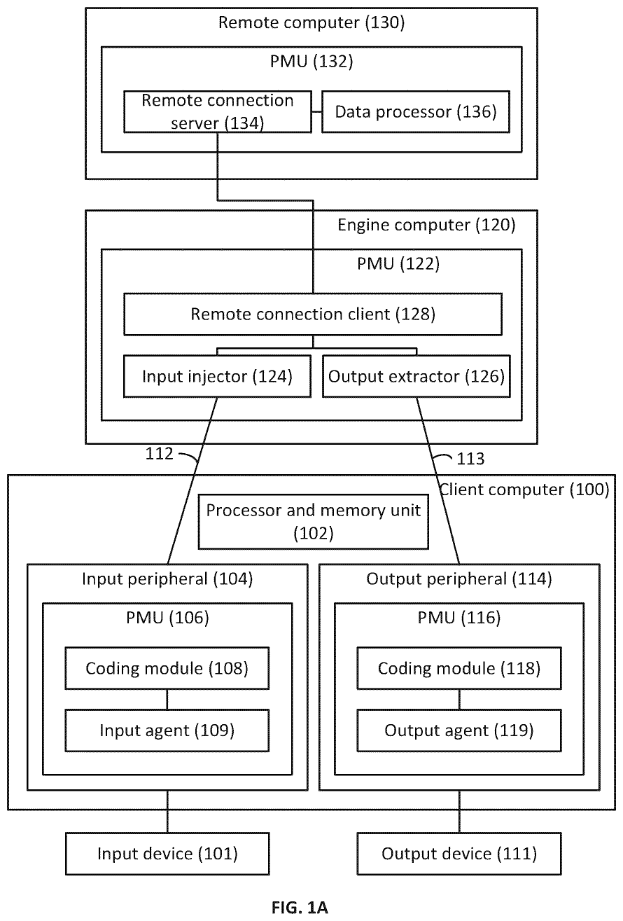

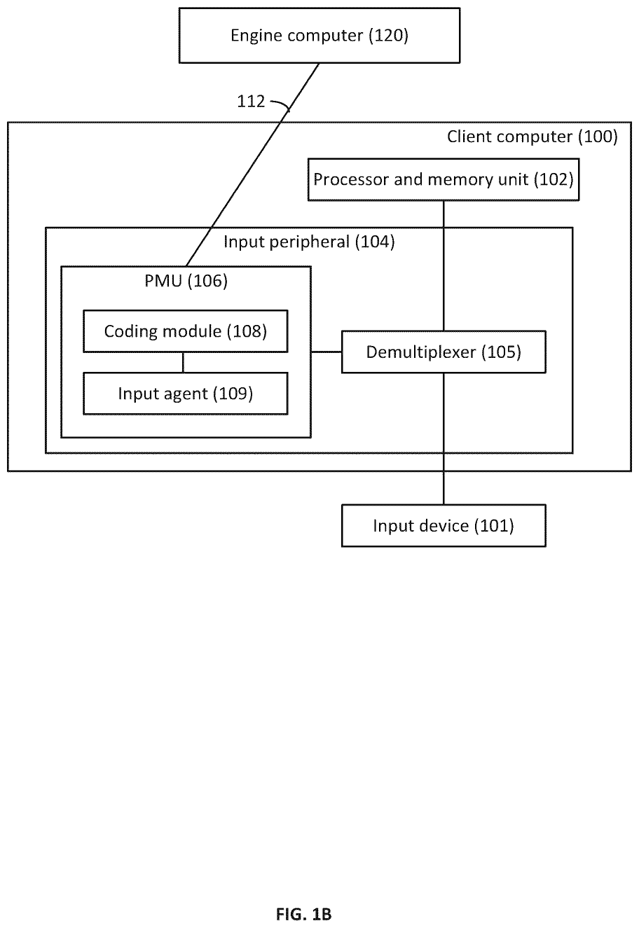

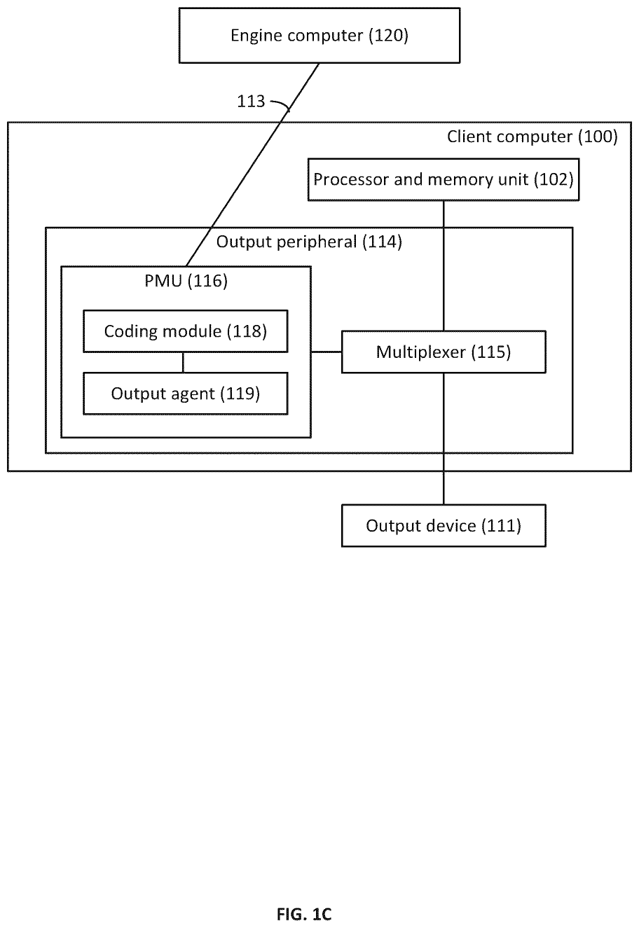

Bearing this in mind, attention is drawn to FIG. 1A illustrating a schematic block diagram of a computerized system of engine-based secure communication between a client computer and a remote computer in accordance with certain embodiments of the presently disclosed subject matter.

The client computer 100 illustrated in FIG. 1A refers to an endpoint or end-user computing device. By way of example, the client computer 100 can be a desktop, a laptop, a smartphone, a tablet, a server, a workstation, or any other type of endpoint device. The client computer 100 may be coupled with a remote computer 130 through a known per se network where the remote computer is configured to provide services and/or resources to the client computer. The remote server can be, by way of example, a remote server or a data center of an organization/enterprise that provides services to its end users. In some cases, the remote computer can be possibly residing in the cloud.

The client computer can comprise a processor and memory unit (PMU) 102, at least an input peripheral component (also referred to herein as input peripheral or input component) 104 and at least an output peripheral component (also referred to herein as output peripheral or output component) 114. PMU 102 is also referred to as processor and memory circuitry, and is configured to provide necessary processing for operating the client computer 100. PMU 102 comprises a processor and a memory operatively coupled thereto. In some embodiments, the memory can refer to memory that can be directly accessible to the processor. The processor can be configured to read instructions stored thereon and execute them as required. It is also to be noted that the term processor referred to herein should be expansively construed to cover any processing circuitry with data processing capabilities, and the present disclosure is not limited to the type or platform thereof, or number of processing cores comprised therein.

The processor can be configured to execute one or more functional components/modules in accordance with computer-readable instructions implemented on a non-transitory computer-readable memory comprised in the memory. Such functional modules are referred to hereinafter as comprised in the PMU. By way of example, functional components comprised in the PMU 102 can comprise an operating system (OS) which can be a secure base OS.

According to certain embodiments, the input peripheral 104 can be connected to an input device 101 which is configured to receive input data from an end user. Non-limiting examples of input devices can include keyboards, pointing devices (such as, e.g., mouse, touch pad, pointing sticks, touch screen, track ball, etc.), and media input devices (such as, e.g., digital cameras, scanners, webcam, recorder, etc.), etc. It is to be noted that the present disclosure is not limited to a specific type of an input device or specific type of input data, and any suitable input device(s) can be utilized herein for the purpose of providing input data. In accordance with certain embodiments, there may be multiple input peripheral components operatively connected to respective multiple input devices (e.g., either of the same type of input devices, such as two keyboards, or of different types).

In some embodiments, the input peripheral 104 can comprise its own PMU 106 which includes functional modules such as a coding module 108 and an input agent module 109 (also referred to as input driver module). The input peripheral 104 can be configured to, upon receiving (e.g., by the input agent 104), input data from an input device 101, transmit the input data to the engine computer 120 through a first secured end-to-end communication channel 112 established between the input peripheral component 104 and the engine computer 120, including encrypting (e.g., by the coding module 108) the input data using a first communication key. The channel establishment and the key creation are described in detail further below. By way of example, a two-way authentication process can be performed (e.g., using asymmetric cryptography), and a communication key (e.g., the first communication key) known to both the input peripheral component 104 and the engine computer 120 can be created and used for encryption of the input data.

By way of example, the input peripheral 104 can be a secured keyboard component configured to encrypt input keystroke data (e.g., by the coding module 108) which is received (e.g., by the input agent) from an input device of a keyboard. In such cases, the coding module 108 thereof can be configured to apply keystroke encryption algorithms to the input keystroke data, e.g., for the purpose of preventing keylogging attacks. By way of example, either a symmetric or asymmetric encryption scheme can be used for encryption of the keystroke data, such as, e.g., RSA, AES, and any other suitable algorithms. By way of example, a symmetric communication key can be shared between the input peripheral 104 and a receiving component (e.g., a corresponding component at the engine computer 120, as will be described in detail below) for both encryption of the input keystrokes and decryption of the encrypted data.

According to certain embodiments, the output peripheral 114 can be connected to an output device 111 which is configured to render output data. Non-limiting examples of output devices can include visual display devices (such as, e.g., screens, monitors, etc.), sound output devices (such as, speakers, headphones, etc.), and printers, etc. It is to be noted that the present disclosure is not limited to a specific type of an output device or specific type of output data, and any suitable output device(s) can be utilized herein for the purpose of rendering output data. In accordance with certain embodiments, there may be multiple output peripheral components operatively connected to respective multiple output devices (e.g., either of the same type of output devices, such as two displays, or of different types).

In some embodiments, the output peripheral 114 can comprise its own PMU 116 which includes functional modules such as a coding module 118 and an output agent module 119.

By way of example, the output peripheral 114 can be a secure display component configured to receive encrypted output data (e.g., by the output agent 119, from the engine computer 120) and decrypt the encrypted output data (e.g., by the coding module 118) to render for display at the output device 111 (e.g., a display device).

In one embodiment, the coding module 118 can be configured to apply decryption algorithms to the encrypted output data, which was previously encrypted at a corresponding transmitting component (e.g., a corresponding component at the engine computer 120, as will be described in detail below). By way of example, similarly as described above, either a symmetric or asymmetric decryption scheme can be used for decryption of the output data. By way of example, a symmetric cryptographic key can be shared between the output peripheral 114 and the transmitting component for both encryption of the output data and decryption of the encrypted output data.

According to certain embodiments, the client computer 100 can comprise a storage unit (not illustrated in the figure) which can be configured to store any data necessary for operating the client computer 100. The storage unit can provide secondary storage to the system and can include, e.g., hard disks, flash memory, etc. Client computer 100 can also comprise a Graphical User Interface (GUI) (not illustrated in the figure) which is configured to enable user-specified inputs and render outputs related to computer 100. In some embodiments, optionally, the output peripheral 114 can further comprise a Graphics processing unit (GPU) for rendering the output to the display. The GPU can be implemented as a part of the PMU 116, or as a separate processing unit.

It is to be noted that the client computer 100 can be any type of stand-alone computer device. Although it is illustrated in FIG. 1A that the input peripheral 104 and the output peripheral 114 are integrated as part of the computer 100, it is to be understood that in some cases, these components can be implemented as separated units which may reside in the same or different physical location as of the computer 100, can be operatively connected to and communicate with the computer 100 through a network. It is also to be noted that although the input device 101 and the output device 111 are illustrated as being external to the client computer 100, this is not necessarily so, and, in some cases, they can form part of the client computer 100.

Although certain embodiments of the present disclosure are exemplified with a client computer with one input peripheral component and one output peripheral component, this is for illustrative purposes only, and should not be construed to limit the scope of the present disclosure in any way. In some embodiments, the client computer 100 can comprise more than one input peripheral component (of the same type or of different types), and/or more than one output peripheral component (of the same type or of different types).

Due to the capabilities of coding (e.g., encrypting and/or decrypting) the input data/output data and the fact that the coded data is most likely not decipherable by any other component/entity, the input peripheral component and output peripheral component configured as above-described are also referred to as secure input peripheral and secure output peripheral. The client computer equipped with the secure peripherals is also referred to as a secure client computer. In some cases, the secure client computer can be provided by a trusted security vendor.

According to certain embodiments, an engine computer 120 is operatively connected to the client computer 100 and to the remote computer 130 as illustrated in FIG. 1A. The engine computer 120 can be a dedicated engine configured to assist/enable the secure communication between the client computer and the remote computer. The engine computer 120 can comprise a PMU 122 of its own, in which a remote connection (RC) client component 128 is accommodated. In some embodiments, the PMU 122 can further comprise an input injector component 124 and an output extractor 126. Typically, the engine computer is a dedicated entity, separate from the client computer and the remote computer. In some embodiments, the engine computer can be possibly hosted by the remote computer, or be integrated as part of the remote computer.

Accordingly, the remote computer 130 is configured to accommodate a RC server component 134 corresponding to the RC client component. The RC client 128 and the RC server 134 are configured to communicate with each other using a RC protocol. The RC protocol used herein should be expansively construed to cover any protocol that enables access to a remote computer over a network connection. In some embodiments, the RC protocol can be implemented through remote desktop virtualization technologies, where application execution takes place on a remote operating system which communicates with a local client device over a network using a remote display protocol through which a user interacts with applications, and all applications and data used remain on the remote system with only input and output information (such as display, keyboard, and mouse information) communicating with the local client device. By way of example, the RC protocol can be implemented as a Virtual desktop infrastructure (VDI) protocol which involves hosting multiple desktop operating system instances for different users on a server hardware platform running a hypervisor. By way of another example, the RC protocol can be implemented as a Remote Desktop Protocol (RDP) which is a server-based computing/presentation virtualization component of Microsoft Windows that allows a user to access applications and data on a remote computer where Remote Desktop Services sessions run in a single shared-server operating system. It is to be noted that the VDI and RDP are illustrated for exemplary purpose only, and other types of RC protocols can be implemented in lieu of the above. For instance, non-limiting examples of the VDI protocol can include Citrix protocol, VMware Horizon protocol, etc.

According to certain embodiments, the engine computer 120 can be configured to, upon receiving (e.g., by the input injector 124 thereof), encrypted input data from the client computer 100, decrypt (e.g., by the input injector 124 or a coding module thereof) the encrypted input data into input data using the second communication key, inject the input data (e.g., by the input injector 124) to the RC client 128, and transmit the input data (e.g., by the RC client 128) to the RC server 134 (under the RC protocol) to be processed by the remote computer 130 (e.g., by the data processor 136 thereof) to generate output data.

The remote computer 130 can be a computer device having data processing capabilities, such as, e.g., a remote server or a data center. The remote computer 130 comprises a PMU 132. The PMU 132 includes a RC server component 134 and a data processor 136. The RC server component 134 is configured to communicate with the RC client 128 under RC protocol. Specifically, the RC server component 134 is configured to receive the input data from the RC client 128, and the data processor 136 is configured to process the input data to generate output data, which is then transmitted by the RC server 134 to the RC client 128. The data processor 136 may further comprise different application modules directed for different processing functionalities. According to certain embodiments, the PMU 132 can comprise driver modules (not illustrated in the figure) capable of data compatibility functionalities, such as translating between non-compatible data types. For instance, a driver comprised therein can translate keystroke data received through the engine computer from the input peripheral 104 for further processing by the data processor 136 or any appropriate application module thereof. Likewise, another driver comprised therein can translate output data processed by the data processor 136 into display data that can be transmitted through the engine computer 120 to the output peripheral 114.

In some embodiments, the remote computer can refer to multiple computer devices collectively providing the data processing services, such as, e.g., a group of networked computers providing cloud services.

The engine computer 120 is further configured to, upon receiving the output data from the RC server (e.g., by the RC client 128) under RC protocol, the output data can be extracted (e.g., by the output extractor 126) from the RC client 128 and transmitted from the engine computer 120 to the output peripheral component 114 through a second secured end-to-end communication channel 113 established there between including encrypting the output data (e.g., by the output extractor 126 or a coding module thereof) using a second communication key known to both the output peripheral component and the engine computer.

The output peripheral 114, upon receiving the encrypted output data from the engine computer, is further configured to decrypt the encrypted output data (e.g., by the coding module 118) into the output data and render the output data (e.g., by the output agent/driver 119) at an output device 111.

In some embodiments, the first and/or second secured end-to-end communication channels can be encapsulated in a virtual private network (VPN) which is set up between operating system of the client computer and the engine computer. In some cases, the RC client and the RC server terminal can communicate with each other via a secure communication channel, such as, e.g., VPN.

It is known that endpoint computers represent key vulnerable points of entry of cyberattacks. Attackers tend to exploit such vulnerabilities, execute malicious code at the endpoints, and exfiltrate assets therefrom. With organizational workforces becoming more mobile and users connecting to internal resources from off-premises endpoints all over the world, endpoints are increasingly susceptible to cyberattacks. Under such circumstances, a remote connection terminal such as the RC client, once being installed locally at an endpoint (e.g., the client computer) and capable of directly communicating with a RC server installed at a remote computer, is susceptible of being compromised by third party attacking of the client computer, thus placing greater risk at the assets of both the client computer and the remote computer.

FIG. 1A proposes an engine-based secure communication scheme using an engine computer which is a computer entity separated from the client computer and dedicated for accommodating the RC terminal. The engine computer can be provided by a trusted security vendor, which in some cases may be the same vendor of the client computer. Having the RC terminal installed on the engine computer and having the input and output data routed through the RC terminal at the engine computer can provide a physical separation between the remote connection client and the client computer, thus providing an added layer of protection. Having the secure input/output peripherals separated from the client computer enables a separation between secure data and non-secure data. In addition, having the input and output data transmitted through secured end-to-end communication channels which are established directly between the secure peripherals (e.g., the input and output peripherals) and the engine computer can enhance the safety of the transmitted data, even in cases where the client computer is compromised.

According to certain embodiments, the client computer 100 can be configured to switch between a secure mode and an open mode (i.e., a non-secure mode) upon a switching condition being met. By way of example, the client computer works in a secure mode in the above-described engine-based secure communication scheme with respect to FIG. 1A, where a dedicated engine computer is used to accommodate the RC client terminal, and secured end-to-end communication channels are established between the RC terminal and the secure input and output peripherals.

In some embodiments, the input peripheral component 104 can further comprise a switching structure, such as, e.g., a demultiplexer (i.e., demux), that is configured to enable the switching between the secure mode and the open mode. Turning now to FIG. 1B, there is illustrated a schematic block diagram of an exemplified input peripheral component enabling the client computer to switch between different modes in accordance with certain embodiments of the presently disclosed subject matter.

As shown, the input peripheral 104 comprise a demultiplexer 105 that at the input side is operatively connected to the input device 101, and at the output side, is selectively connected to the PMU 106 of the input peripheral 104 or the PMU 102 of the client computer 100. The demultiplexer 105 is configured to receive the input data from the input device 101, and direct the input data to the PMU 106 (e.g., to the coding module 108 thereof) of the input peripheral 104 upon switching to the secure mode, where the input data will be encrypted by the coding module 108 for purpose of being transmitted to the engine computer 120 through the secured end-to-end communication channel 112, as described above with respect to FIG. 1A. Upon switching to the open mode, the demultiplexer 105 can direct the input data to the PMU 102 of the client computer 100 (e.g., to the motherboard of the client computer) to be locally processed to generate output data, and the generated output data is transmitted by the PMU 102 to the output peripheral 114 for rendering at the output device 111. It is to be noted that in some cases, the demultiplexer can be implemented as a hardware-based switch, while in some other cases, it can be implemented as a software module whose functionality can be regarded as being comprised in the PMU 106.

According to certain embodiments, the client computer 100 can switch between the secure mode and the open mode upon a switching condition being met, where the switching condition can be selected from a group comprising: automatic switch per predetermined time interval, and manual switch by a user. By way of example, the manual switch can be performed by a user through a physical component embedded/integrated on the client computer, such as, e.g., a switch button on the keyboard, or alternatively by using a specific keystroke combination through the keyboard. By way of another example, the manual switch can be triggered by a specific way (e.g., a specific orientation or angle/tilt) that the user holds the client computer. By a further example, the manual switch can be triggered by connecting a portable key to the client computer by a user.

According to certain embodiments, the switching instruction can be provided by the PMU 106 to the demultiplexer, upon the switching condition being met. Once the demultiplexer receives the instruction, it directs, according to the instruction, the input data to the PMU 106 which will encrypt the input data and transmit the encrypted data to the engine computer, or directs the input data to the PMU 102 of the client computer 100 to be processed locally.

In some embodiments, once the client computer switches between working modes, a physical indication can be provided to inform the user that the switch is successfully completed. By way of example, a physical indicator that can be integrated on the keyboard or any other suitable component of the client computer, can provide a physical indication by way of, e.g., light, mini-screen, buzz, sound, etc., so that the user is informed that the switching actually takes place.

Accordingly, in some embodiments, the output peripheral component 114 can further comprise a switching structure, such as, e.g., a multiplexer (i.e., mux), that is configured to switch between the secure mode and the open mode and provide the corresponding output. Turning now to FIG. 1C, there is illustrated a schematic block diagram of an exemplified output peripheral component enabling the switch between different modes and providing the output in accordance with certain embodiments of the presently disclosed subject matter.

As shown, the output peripheral 114 comprise a multiplexer 115 that, at the input side, is selectively connected to the PMU 116 of the output peripheral 114 or the PMU 102 of the client computer 100, and at the output side, is operatively connected to the output device 111. In secure mode, the multiplexer 115 is configured to receive the output data from the PMU 116 (e.g., from the coding module 118 thereof) of the output peripheral 114. In open mode, the multiplexer 115 is configured to receive the output data from the PMU 102 of the client computer 100. The received output data is transmitted by the multiplexer 115 to the output device 111 to render for display. It is to be noted that in some cases, the multiplexer can be implemented as a hardware-based switch, while in some other cases, it can be implemented as a software module whose functionality can be regarded as being comprised in the PMU 116.

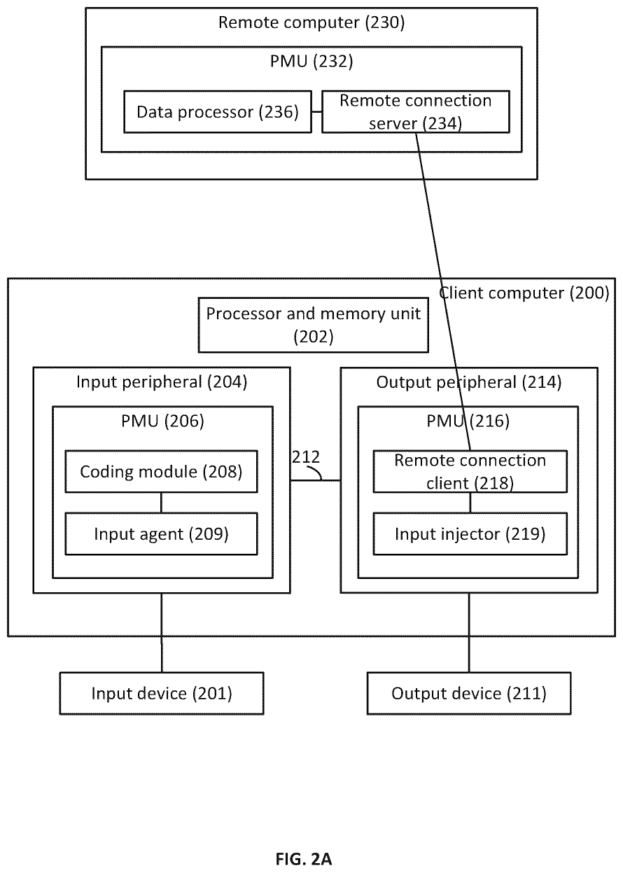

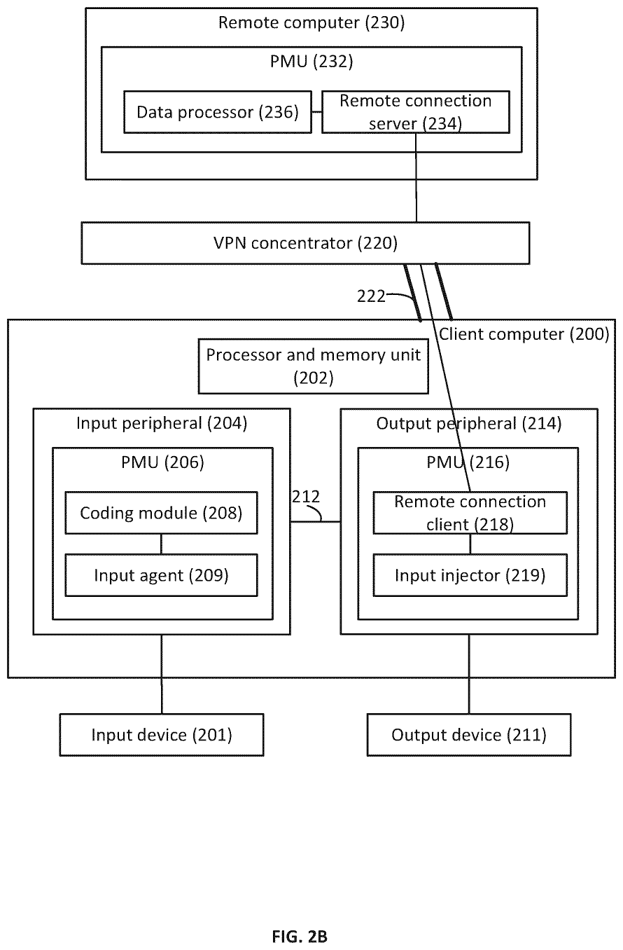

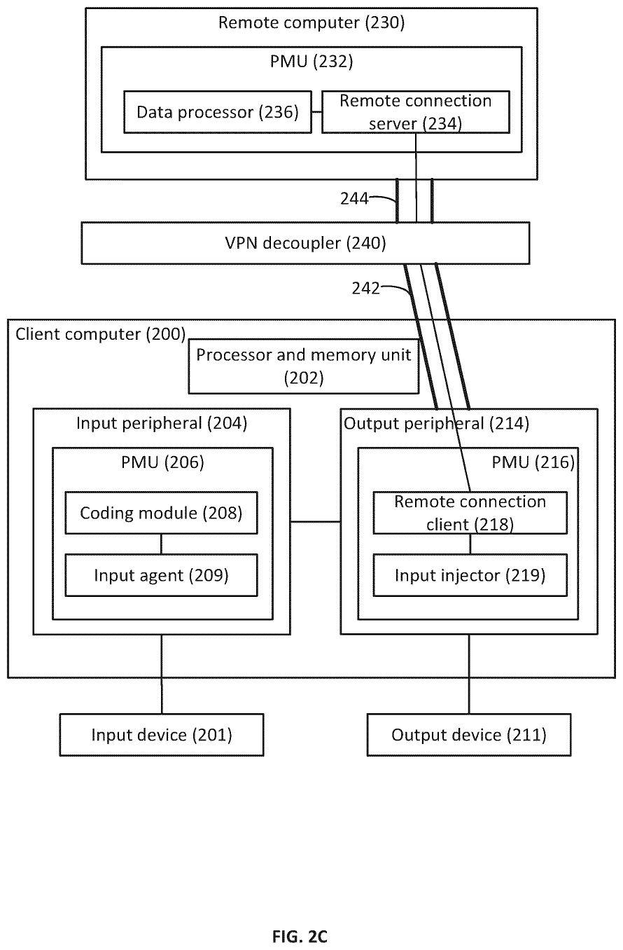

Turning now to FIG. 2A, there is illustrated a schematic block diagram of another computerized system of secure communication between a client computer and a remote computer in accordance with certain embodiments of the presently disclosed subject matter. This is also referred to as the “slim” communication scheme as compared to the “engine-based” scheme described with reference to FIG. 1A, as will be described further below.

Similarly to the client computer 100 as described with respect to FIG. 1A, the client computer 200 illustrated in FIG. 2A also refers to an endpoint computing device. The client computer 200 is coupled with a remote computer 230 (e.g., a remote server or a data center, possibly residing in the cloud) through a known per se network where the remote computer is configured to provide services to the client computer.

The client computer can comprise a processor and memory unit (PMU) 202, at least an input peripheral component 204 and at least an output peripheral component 214. PMU 202 is configured to provide necessary processing for operating the client computer 200. PMU 202 comprises a processor and a memory operatively coupled thereto. The processor can be configured to execute one or more functional components/modules in accordance with computer-readable instructions implemented on a non-transitory computer-readable memory comprised in the memory. Such functional modules are referred to hereinafter as comprised in the PMU. By way of example, functional components comprised in the PMU 202 can comprise an operating system (OS) which can be a secure base OS.

According to certain embodiments, the input peripheral 204 can be connected to an input device 201 which is configured to receive input data from an end user. In some embodiments, the input peripheral 204 can comprise its own PMU 206 which includes functional modules such as a coding module 208 and an input agent module 209.

The input peripheral 204 can be configured to, upon receiving (e.g., by the input agent 204), input data from an input device 201, transmit the input data to the output peripheral 214 through a secured end-to-end communication channel 212 established between the input peripheral 204 and the output peripheral 214, including encrypting (e.g., by the coding module 208) the input data using a communication key. The channel establishment and the key creation are described in detail further below. By way of example, a two-way authentication process can be performed (e.g., using asymmetric cryptography), and a communication key known to known to both the input peripheral 204 and the output peripheral 214 can be created and used for encryption of the input data.

By way of example, the input peripheral 204 can be a secured keyboard component configured to encrypt input keystroke data (e.g., by the coding module 208) which is received (e.g., by the input driver) from an input device of a keyboard. In such cases, the coding module 208 thereof can be configured to apply keystroke encryption algorithms to the input keystroke data. By way of example, a symmetric communication key can be shared between the input peripheral 204 and the output peripheral 214 for both encryption of the input keystrokes and decryption of the encrypted data.

According to certain embodiments, the output peripheral 214 can be connected to an output device 211 which is configured to render output data. In some embodiments, the output peripheral 214 can comprise its own PMU 216 which includes functional modules such as a remote connection (RC) client module 218 and an input injector module 219.

The input injector 219 can be configured to receive the encrypted input data from the input peripheral 204, decrypt the encrypted data into the original input data using the communication key shared between the input peripheral 204 and the output peripheral 214, and inject the input data into the RC client module 218. The RC client 218 can be configured to transmit the input data to the RC server 234 (comprised in the remote computer 230) to be processed by the remote computer 234 to generate output data.

Similarly, as described with respect to FIG. 1A, the remote computer 230 can be a computer device having data processing capabilities, such as, e.g., a remote server or a data center. The remote computer 230 comprises a PMU 232. The PMU 232 includes a RC server component 234 and a data processor 236. The RC server component 234 is configured to communicate with the RC client 218 comprised in the output peripheral 214 under RC protocol. Specifically, the RC server component 234 can be configured to receive the input data from the RC client 218, and the data processor 236 is configured to process the input data to generate output data, which is then transmitted by the RC server 234 to the RC client 218. The data processor 236 may further comprise different application modules directed for different processing functionalities. According to certain embodiments, the PMU 232 can comprise driver modules (not illustrated in the figure) capable of data compatibility functionalities, such as translating between non-compatible data types. For instance, a driver comprised therein can translate keystroke data received from the output peripheral 214 for further processing by the data processor 236 or any appropriate application module thereof. Likewise, another driver comprised therein can translate output data processed by the data processor 236 into display data that can be transmitted to the output peripheral 214.

Upon receiving the output data by the RC client 218 from the RC server 234, the output peripheral 214 can be configured to render the output data at the output device 211. By way of example, the output peripheral 214 can be a secure display component configured to receive display output data from the RC server 234 and render such data for display at the output device 211 (e.g., a display device).

According to certain embodiments, the client computer 200 can comprise a storage unit (not illustrated in the figure) which can be configured to store any data necessary for operating the client computer 200. The storage unit can provide secondary storage to the system and can include, e.g., hard disks, flash memory, etc. In some cases, client computer 200 can also comprise a Graphical User Interface (GUI) (not illustrated in the figure) which is configured to enable user-specified inputs and render outputs related to computer 200.

The secure communication scheme as proposed in FIG. 2A recites a more concise system structure which does not involve a dedicated engine computer, as compared to the engine-based scheme described with respect to FIG. 1A, thus is also referred to as a “slim” communication scheme. Specifically, it is proposed to have the RC client terminal accommodated by the output peripheral component of the client computer, and have the input data transmitted through a secured end-to-end communication channel which is established directly between the secure input peripheral and the secure output peripheral. Therefore, even if the client computer (e.g., the base OS thereof) is potentially compromised by third party attacks, the input data which is transmitted within the client computer is still protected due to the secured end-to-end communication channel. The output data that is directly transmitted from the remote computer to the output peripheral using the RC protocol with its built-in security capabilities is also protected. The special setting of RC client residing within the secure output peripheral, as opposed to residing in the base OS of the client computer, can provide separation between the portal of the remote connection and the base OS, thus providing enhanced safety of the transmitted data, even in cases where the client computer is compromised.

The slim scheme, as compared to the engine-based scheme, utilizes a simpler system architecture to achieve secure communication between the two computer entities, which is not only easier for implementation and integration, but also has an additional advantage of reducing communication latency or communication synchronization issues (which may be caused due to the relay of the engine computer in the engine-based scheme).

In some cases, in order to accommodate the RC client at the output peripheral component, specific configurations (with respect to hardware and/or software) may be required in order to guarantee compatibility between the RC terminal and the output peripheral, which may depend on factors such as, e.g., the type/version of RC terminals, the hardware implementation of the output peripheral, etc. By way of example, the optimization/configuration of the output peripheral may be hardware-specific (e.g., specific to the hardware used to implement the output peripheral).

According to certain embodiments, the RC client can communicate with the RC server (using RC protocol) via a virtual private network (VPN) that is set up between the base OS of the client computer and the remote computer. By way of example, the remote connection between the RC client and RC server can be realized using port forwarding through the base OS of the client computer via the VPN.

Accordingly, in cases where there are multiple client computers simultaneously communicating with the remote computer (e.g., a remote server of an organization/enterprise for providing services to its end users), multiple VPN connections need to be established between respective client computers (e.g., the operating systems thereof) and the remote computer for encapsulating the remote connection, which may necessarily cause increased overhead of VPN configuration and management at the remote computer, and may even cause potential security hazards in cases where the remote computer is not properly secured by the owner organization.

In some cases, a VPN concentrator can be used as an intermediate entity that centrally manages VPN communication infrastructures in multi-user environments. In principle, a VPN concentrator may act like a VPN server using tunnelling protocols to create and manage VPN tunnels. It also manages user authentication, and assigns IP addresses and cryptographic keys. The VPN concentrator serves as a termination point for the multiple VPN connections from the client computers. Upon completing a decryption process with respect to the input data received from the client computers via respective VPN tunnels, the VPN Concentrator forwards the input data to an organization's remote server.

According to certain embodiments of the presently disclosed subject matter, a VPN concentrator that is operatively connected to the client computer and the remote computer can be used to centrally manage the VPN connections from multiple client computers and forward the input from there onwards to the remote computer.

Turning now to FIG. 2B, there is illustrated a schematic block diagram of the secure communication system as described with respect to FIG. 2A enhanced with a VPN concentrator in accordance with certain embodiments of the presently disclosed subject matter.

As described above, the RC client 218 communicates with the RC server 234 using RC protocol, such as RDP or VDI. In some embodiments, the input data is transmitted from the RC client to the RC server under the RC protocol via a VPN 222 that is set up between the base OS (as comprised in the PMC 202) of the client computer 200 and a dedicated VPN concentrator 220 (e.g., provided by a trusted vendor). Although only one client computer is shown in FIG. 2B, in practice one or more additional client computers can simultaneously communicate with the remote computer 230 via the VPN concentrator 220. For establishing the VPN connection with respect to each client computer, the VPN concentrator 220 manages user authentication, and assigns IP addresses and cryptographic keys. Upon receiving the incoming data transmitted via the VPN 222 from the client computer, the VPN concentrator 220 decrypts the input data (with respect to the encryption enforced by the VPN tunnel, i.e., terminates the VPN connection), and forwards the input data to the remote computer 230 (e.g., to the RC server 234 in the remote computer 230).

According to further embodiments, a VPN can be set up directly between the output peripheral component and the remote computer, as opposed to between the base OS of the client computer and the remote computer, thus effectively removes the attack surface of the RC protocol that is present in the base OS of the client computer (in cases where the client computer is compromised).

In such cases, the input data is transmitted from the RC client to the RC server under the RC protocol via a first VPN that is set up directly between the output peripheral component of the client computer and an VPN decoupler, and subsequently via a second VPN that is set up between the VPN decoupler and the remote computer. In such cases, a VPN decoupler is used instead of a VPN concentrator, as an intermediate entity operatively connect to the client computer and the remote computer. A VPN decoupler may act like a VPN router/adaptor. When connecting to the VPN decoupler, the client computers' network traffic is redirected and reshaped by the VPN decoupler. Specifically, the VPN decoupler is configured to decrypt the input data (with respect to the encryption enforced by the first VPN tunnel, i.e., decouple the first VPN connection), re-encrypt the input data, and send the re-encrypted data to the remote computer (i.e., via the second VPN tunnel).

In some embodiments, for each client computer, a respective VPN decoupler can be used for connecting the client computer to the remote computer. Alternatively, one VPN decoupler can be used for centrally managing and connecting multiple client computers to the remote computer. In such cases, the VPN decoupler can be regarded as an entity integrating the functionalities of both the VPN concentrator and the VPN decoupler.

Turning now to FIG. 2C, there is illustrated a schematic block diagram of the secure communication system as described with respect to FIG. 2A enhanced with a VPN decoupler in accordance with certain embodiments of the presently disclosed subject matter.

As illustrated, the remote connection between the RC client and the RC server is via a first VPN 242 that is set up between the output peripheral component 214 of the client computer 200 and a VPN decoupler 240 (e.g., provided by a trusted vendor), and then via a second VPN 244 that is set up between the VPN decoupler 240 and the remote computer 230. The first VPN can be a dedicated VPN provided by the trusted vendor thus can be configured with enhanced security features. The second VPN 244 can be an organizational VPN provided by the organization of the remote computer. Under such configuration, the RC client and the RC server terminals are both encapsulated inside VPN and therefore are not viable attack surfaces.

It is to be noted that the ability of the client computer switching between secure mode and open mode as described above with respect to FIG. 1B, as well as the possible structure and configuration thereof enabling such switching, is also applicable to the embodiments described with respect to FIGS. 2A, 2B and 2C.

For purpose of brevity of the description, although certain details and/or examples with respect to similar entities which are described above with respect to FIGS. 1A and 1B are not repeated when describing the FIGS. 2A, 2B and 2C, it should be noted that such details and/or examples are applicable wherever appropriate.

It is noted that the client computer, the remote computer, the engine computer, and/or certain components thereof, such as, e.g., the input peripheral component and the output peripheral component, can be implemented as any kind of computerized device within which a set of instructions, for causing the computer to perform any one or more of the methodologies discussed herein, may be executed. By way of example, in some cases, the input peripheral component and/or the output peripheral component can be implemented as a system on a chip (SoC) which is an integrated circuit that integrates all or at least part of the functionality thereof.

In some embodiments, the client computer and the remote computer may operate as client and server in client-server network environment or in a cloud computing infrastructure/environment, or as peer entities in a peer-to-peer (or distributed) network environment.

Further, while a single computer is described, the term “computer” shall also be taken to include any collection of computers that individually or jointly execute a set (or multiple sets) of instructions to perform any one or more of the methodologies discussed herein.

Those versed in the art will readily appreciate that the teachings of the presently disclosed subject matter are not bound by the system illustrated in FIGS. 1A, 1B, 2A, 2B and 2C; equivalent and/or modified functionality can be consolidated or divided in another manner and can be implemented in any appropriate combination of software with firmware and hardware.

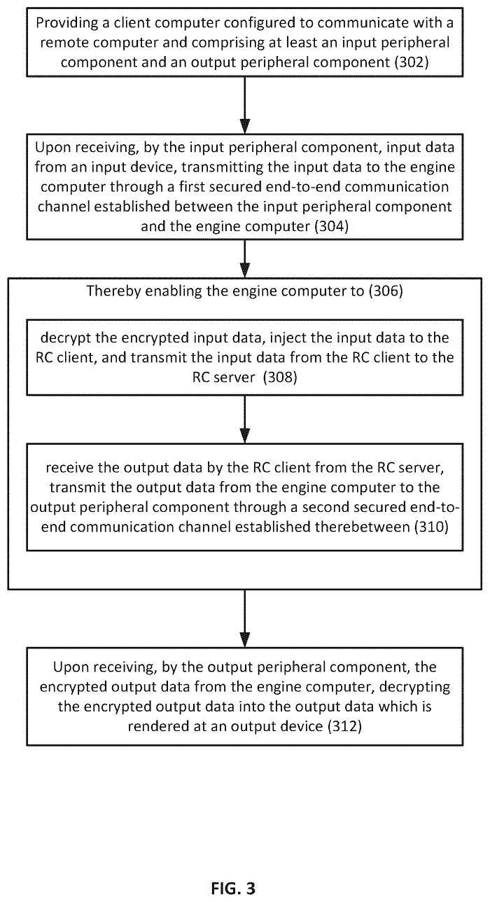

While not necessarily so, the process of operations of the systems described with respect to FIGS. 1A, 1B and 1C can correspond to some or all of the stages of the methods described with respect to FIGS. 3-5. Likewise, the methods described with respect to FIGS. 3-5 and their possible implementations can be implemented by the systems described with respect to FIGS. 1A, 1B and 1C. It is therefore noted that embodiments discussed in relation to the methods described with respect to FIGS. 3-5 can also be implemented, mutatis mutandis as various embodiments of the systems described with respect to FIGS. 1A, 1B and 1C, and vice versa.

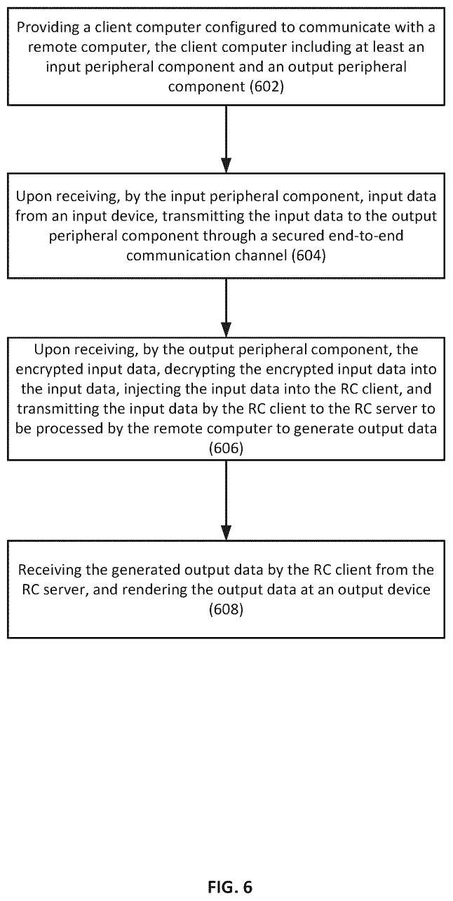

Similarly, the process of operations of the systems described with respect to FIGS. 2A, 2B and 2C can correspond to some or all of the stages of the methods described with respect to FIG. 6. Likewise, the methods described with respect to FIG. 6 and their possible implementations can be implemented by the systems described with respect to FIGS. 2A, 2B and 2C. It is therefore noted that embodiments discussed in relation to the methods described with respect to FIG. 6 can also be implemented, mutatis mutandis as various embodiments of the systems described with respect to FIGS. 2A, 2B and 2C, and vice versa.

Turning now to FIG. 3, there is illustrated a generalized flowchart of engine-based secure communication between a client computer and a remote computer (from the client computer's perspective) in accordance with certain embodiments of the presently disclosed subject matter.

As described above with respect to FIG. 1A, a client computer refers to an endpoint or end-user computing device which may be coupled with a remote computer through a known per se network, where the remote computer is configured to provide services and/or resources to the client computer. The remote server can be, by way of example, a remote server or a data center of an organization/enterprise that provides services to its end users. In some cases, the remote computer can be possibly residing in the cloud.

The client computer is provided (302) which is configured to communicate with the remote computer. The client computer includes at least an input peripheral component and an output peripheral component. An engine computer is operatively connected to the client computer and to the remote computer. The engine computer is configured to accommodate a remote connection (RC) client, while the remote computer is configured to accommodate a RC server. The RC client and the RC server are configured to communicate with each other using a RC protocol. Non-limiting examples of RC protocol can be RDP or VDI, as described above.

Upon receiving, by the input peripheral component (e.g., by the input agent 109 thereof, as illustrated in FIG. 1A), input data from an input device, (304) (e.g., by the coding module 108 thereof) the input data to the engine computer is transmitted through a first secured end-to-end communication channel established between the input peripheral component and the engine computer, including encrypting the input data using a first communication key.

According to certain embodiments, the first secured end-to-end communication channel can be established by performing a two-way authentication between the input peripheral component and the engine computer, and creating the first communication key usable for encryption. There is now described an exemplified process of establishing the secured end-to-end communication channel in accordance with certain embodiments of the present disclosure.

By way of example, the input peripheral component may authenticate the engine computer using a non-symmetric key that includes a private key known to only the engine computer. More specifically, the engine computer may send a message signed by its private key, and the input peripheral may extract the corresponding public key of the engine computer (e.g., from a trusted source) and decipher, using the engine computer's public key, the so-encrypted message, thereby authenticating the engine computer.

Then, the input peripheral component may encrypt the message using a non-symmetric key that includes a private key known only to the input peripheral component, and the remote computer may then decipher the message using a corresponding public key of the input peripheral component (extracted e.g., from the external trusted source), thereby authenticating the input peripheral component. Once the two-way authentication (also termed dual authentication) has been achieved, a secured end-to-end communication channel between the input peripheral component and the engine computer is established.

Next, a first communication key (e.g., a symmetric key), known to the authenticated engine and the authenticated input peripheral component, is generated. The symmetric key is usable for the data coding between the client computer and the engine. By one example, in order to establish the communication key, the input peripheral may extract proprietary data from a Trusted Platform Module (TPM) and/or an external trusted source, and combine them, thereby generating the communication key. In some cases, generation of the communication key can be regarded as part of the establishment process of the secured end-to-end communication channel.

In accordance with certain embodiments, in order to send the communication key to the authenticated engine computer, the communication key may be encrypted by the private key of the input peripheral and by the public key of the engine computer, and transmitted from the input peripheral component to the engine computer, through the already established secured channel between them. Since the communication key was encrypted by the public key of the engine computer, this guarantees that only the already authenticated engine computer can decipher it (using its corresponding private key, known only to it). The engine computer, in turn, will use the public key of the already authenticated input peripheral in order to decipher and extract the communication key that was encrypted by the corresponding private key of the input peripheral component. Thus, a communication key (e.g., the first communication key) is established between the authenticated input peripheral component and the authenticated engine computer and is known only to them for transmitting coded data (secured payload).

The present disclosure is not bound by the specified manner of generating and/or establishing the communication key. For instance, the procedure may commence from the engine computer which defines the communication key, encrypt it with its private key, and then with the public key of the authenticated input peripheral component. The authenticated input peripheral component, in turn, will use the authenticated engine computer public key and its own private key to decipher and extract the communication key, for transmitting code data and achieving secured payload.

It is to be noted that in some cases (such as, e.g., when working in the secure mode), the secured end-to-end communication channel can be established once, and the input data received afterwards can be transmitted within such a channel. In some other cases, it is also possible that a new secured end-to-end communication channel will be established every time when receiving new input data, and/or after a predetermined time period. The present disclosure is not limited by the frequency of establishment of the secured end-to-end communication channel.

By way of example, the secured end-to-end communication channel can be implemented using TLS/SSL (Transport Layer Security/Secure Sockets Layer) encryption.

Continuing with the description of FIG. 3, once the input data is transmitted from the input peripheral to the engine computer through the first secured end-to-end communication channel, it enables (306) the engine computer to perform the following operations: decrypt (308) the encrypted input data using the first communication key, inject the input data to the RC client, and transmit the input data from the RC client to the RC server to be processed by the remote computer to generate output data; and further receive (310) the output data by the RC client from the RC server (once the output data is generated by the remote computer), and transmit the output data from the engine computer to the output peripheral component through a second secured end-to-end communication channel established there between by encrypting the output data using a second communication key.

The second secured end-to-end communication channel can be established in a similar manner as described above with respect to the first secured end-to-end communication channel. In some embodiments, the first and/or second secured end-to-end communication channels can be encapsulated in a virtual private network (VPN) which is set up between the operating system of the client computer and the engine computer.

Upon receiving, by the output peripheral component (e.g., by the output agent 119 thereof, as illustrated in FIG. 1A), the encrypted output data from the engine computer, decrypting (e.g., by the coding module 118 thereof) the encrypted output data into the output data which is rendered at an output device (e.g., the output device 111).

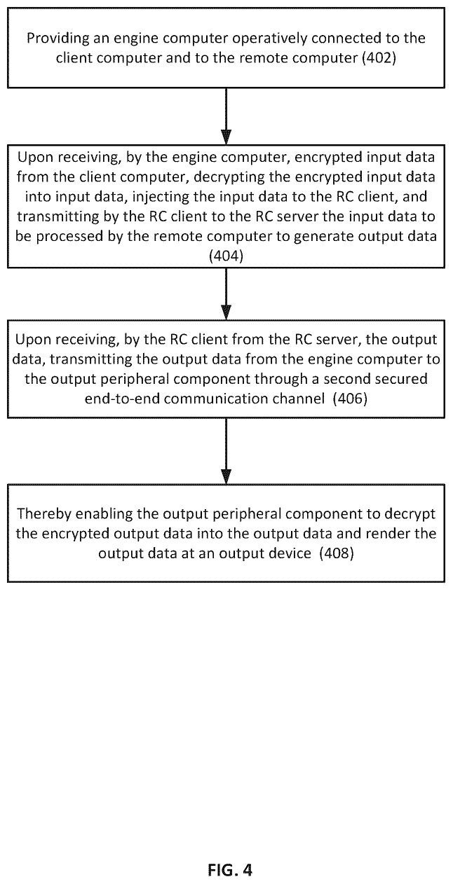

Turning now to FIG. 4, there is illustrated a generalized flowchart of the engine-based secure communication between a client computer and a remote computer (from the engine computer's perspective) in accordance with certain embodiments of the presently disclosed subject matter.

For enabling a secure communication between the client computer and the remote computer, an engine computer operatively connected to the client computer and to the remote computer can be provided (402) (e.g., by a trusted vendor). The engine computer is configured to accommodate a remote connection (RC) client, while the remote computer is configured to accommodate a corresponding RC server. The RC client and the RC server are configured to communicate with each other using a RC protocol.

Upon receiving, by the engine computer (e.g., by the input injector 124 thereof), encrypted input data from the client computer, the encrypted input data can be decrypted (e.g., by the input injector 124 or a coding module thereof) into input data, and the input data can be injected to the RC client, and transmitted by the RC client (e.g., by the RC client 128) to the RC server to be processed by the remote computer to generate output data. As described above, the client computer includes at least an input peripheral component and an output peripheral component. The encrypted input data is generated based on the input data received by the input peripheral component from an input device, and transmitted from the input peripheral component to the engine computer through a first secured end-to-end communication channel established there between by encrypting the input data using a first communication key known to both the input peripheral component and the engine computer, as described above with respect to FIG. 3.

Upon receiving the output data, by the RC client (e.g., by the RC client 128) from the RC server, the output data can be transmitted (406) (e.g., by the output extractor 126) from the engine computer to the output peripheral component through a second secured end-to-end communication channel established there between including encrypting the output data using a second communication key, thereby enabling (408) the output peripheral component to decrypt the encrypted output data into the output data and render the output data at an output device. The establishment of the first and second secured end-to-end communication channels are described above in detail, thus is not repeated here.

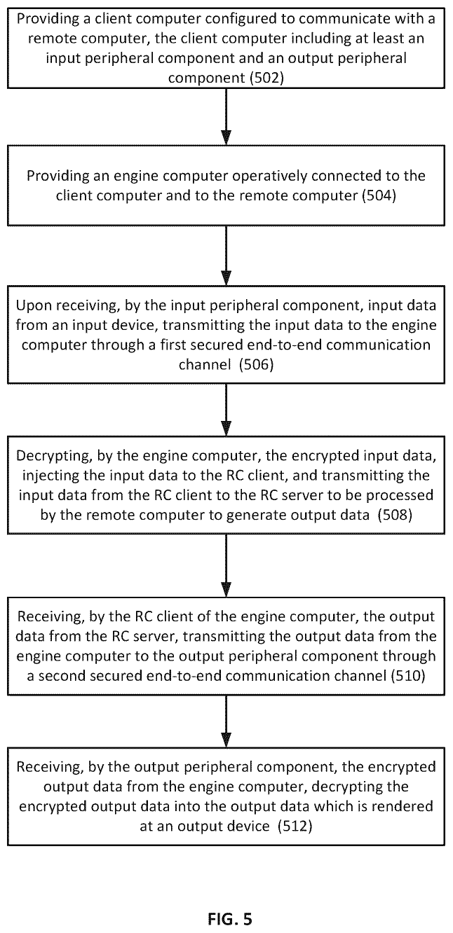

Turning now to FIG. 5, there is illustrated a generalized flowchart of the engine-based secure communication between a client computer and a remote computer (from both the client computer and the engine computer's perspective) in accordance with certain embodiments of the presently disclosed subject matter.

A client computer configured to communicate with a remote computer can be provided (502). The client computer includes at least an input peripheral component and an output peripheral component.

An engine computer operatively connected to the client computer and to the remote computer can be provided (504). The engine computer is configured to accommodate a remote connection (RC) client, while the remote computer is configured to accommodate a RC server. The RC client and the RC server are configured to communicate with each other using a RC protocol. While not necessarily so, in some cases, the client computer and the engine computer can be provided by the same trusted vendor, e.g., for the purpose of providing all necessary infrastructures to enable secure communication between the end users of an organization and the organizational server.

Upon receiving, by the input peripheral component (e.g., by the input agent 109 thereof) of the client computer, input data from an input device, the input data can be transmitted (506) (e.g., by the coding module 108 thereof) to the engine computer through a first secured end-to-end communication channel established between the input peripheral component and the engine computer, including encrypting the input data using a first communication key.

The encrypted input data can be decrypted (508), by the engine computer (e.g., by the input injector 124 or a coding module thereof) using the first communication key (e.g., known to both the input peripheral component and the engine computer), and the input data can be injected to the RC client, and transmitted from the RC client to the RC server to be processed by the remote computer to generate output data.

The output data can be received (510), by the RC client (e.g., by the RC client 128) of the engine computer from the RC server, and transmitted (e.g., by the output extractor 126) from the engine computer to the output peripheral component through a second secured end-to-end communication channel established there between by encrypting the output data using a second communication key.

The encrypted output data can be received (512), by the output peripheral component (e.g., by the output agent 119 thereof) from the engine computer, and decrypted (e.g., by the coding module 118) into the output data which is rendered at an output device.

In the engine-based secure communication schemes as described with respect to FIGS. 3-5, an engine computer which is a dedicated and separated computer entity is used for accommodating the RC terminal. The engine computer can be provided by a trusted vendor. Having the input and output data routed through the RC terminal at the engine computer can provide a physical separation between the portal of the remote connection and the client computer, thus providing an added layer of protection. Once the input data is received by the input peripheral component of the client computer, this data can be transmitted securely to the remote computer via the engine computer, and the output data can be securely transmitted back in a similar manner, therefore ensuring an entire process from input to output being securely protected end-to-end, such protection being valid against compromise of the client computer and/or the network.

Turning now to FIG. 6, there is illustrated a generalized flowchart of secure communication between a client computer and a remote computer in accordance with certain embodiments of the presently disclosed subject matter.

As compared to the engine-based scheme as described with respect to FIGS. 3-5, FIG. 6 provides a slim scheme (i.e., engine-less) of secure communication. Specifically, a client computer configured to communicate with a remote computer is provided (602). The client computer includes at least an input peripheral component and an output peripheral component. The output peripheral component is configured to accommodate a remote connection (RC) client, while the remote computer is configured to accommodate a RC server. The RC client and the RC server are configured to communicate with each other using a RC protocol.

Upon receiving, by the input peripheral component (e.g., by the input agent 209 as illustrated in FIG. 2A), input data from an input device, the input data can be transmitted (604) (e.g., by the coding module 208) to the output peripheral component through a secured end-to-end communication channel established between the input peripheral component and the output peripheral component including encrypting the input data using a communication key.

Upon receiving the encrypted input data by the output peripheral component (e.g., by the input injector 219), the encrypted input data can be decrypted (606) (e.g., by the input injector 219) using the communication key to decrypt into the input data. The input data can be injected into the RC client, and transmitted by the RC client (e.g., by the RC client 218) to the RC server to be processed by the remote computer to generate output data.

The generated output data can be received (608) by the RC client (e.g., by the RC client 218) from the RC server, and can be rendered at an output device.

In the slim secure communication scheme as described with respect to FIG. 6, there is no dedicated engine computer involved, and, instead, the RC client terminal is accommodated by the output peripheral component of the client computer, and the input data is transmitted through a secured end-to-end communication channel directly from the secure input peripheral to the secure output peripheral, and then to the remote computer through remote connection, such as RDP with its built-in security. Therefore, the input data can be transmitted securely to the remote computer and the output data can be securely transmitted back for rendering display, thereby ensuring an entire process, from input to output, being securely protected end-to-end, such protection being valid against compromise of the client computer and/or the network.

In addition, the slim scheme utilizes a simpler system architecture which is easier for implementation and integration, and has an additional advantage of reducing communication latency, as compared to the engine-based scheme.

It is to be noted that the examples shown in the figures and described above are only for illustrative purposes and should not be deemed to limit the present disclosure in any way. Anyone skilled in the art would readily appreciate that any other suitable implementations or illustrations can be used in addition to or in lieu of the illustrated examples.

It is also noted that whilst the flow charts illustrated in in FIGS. 3-6 are described with reference to elements of the systems described with respect to FIGS. 1A, 1B, 2A, 2B and 2C, this is by no means binding, and the operations can be performed by elements other than those described herein.

It is to be understood that the present disclosure is not limited in its application to the details set forth in the description contained herein or illustrated in the drawings.

It will also be understood that the system according to the present disclosure may be, at least partly, implemented on a suitably programmed computer. Likewise, the present disclosure contemplates a computer program being readable by a computer for executing the method of the present disclosure. The present disclosure further contemplates a non-transitory computer-readable memory tangibly embodying a program of instructions executable by the computer for executing the method of the present disclosure.

The present disclosure is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

Those skilled in the art will readily appreciate that various modifications and changes can be applied to the embodiments of the present disclosure as herein before described without departing from its scope, defined in and by the appended claims.

1. A computerized method of secure communication between a client computer and a remote computer, the method comprising:
providing an engine computer operatively connected to the client computer and to the remote computer, wherein the engine computer is configured to accommodate a remote connection (RC) client, the remote computer is configured to accommodate a RC server, and wherein the RC client and the RC server are configured to communicate with each other using a RC protocol;
upon receiving, by the engine computer, encrypted input data from the client computer, decrypting the encrypted input data into input data, injecting the input data to the RC client, and transmitting by the RC client to the RC server the input data to be processed by the remote computer to generate output data, wherein the client computer includes at least an input peripheral component and an output peripheral component, and wherein the encrypted input data is generated based on the input data received by the input peripheral component from an input device, and transmitted from the input peripheral component to the engine computer through a first secured end-to-end communication channel established there between by encrypting the input data using a first communication key; and
upon receiving, by the RC client from the RC server, the output data, transmitting the output data from the engine computer to the output peripheral component through a second secured end-to-end communication channel established there between including encrypting the output data using a second communication key;
thereby enabling the output peripheral component to decrypt the encrypted output data into the output data and render the output data at an output device.

2. The computerized method according to claim 1, wherein the RC protocol is Virtual desktop infrastructure (VDI) protocol or a Remote Desktop Protocol (RDP).

3. The computerized method according to claim 1, wherein the engine computer is integrated as a part of the remote computer.

4. The computerized method according to claim 1, wherein the first and second secured end-to-end communication channel are each established by performing a two-way authentication, and creating a communication key usable for encryption.

5. The computerized method according to claim 1, wherein the first and second secured end-to-end communication channels are each encapsulated in a virtual private network (VPN) which is set up between an operating system of the client computer and the engine computer.

6. The computerized method according to claim 1, wherein the RC client and the RC server communicate with each other via a virtual private network (VPN).

7. A computerized method of secure communication between a client computer and a remote computer, the method comprising:
providing a client computer configured to communicate with a remote computer, the client computer including at least an input peripheral component and an output peripheral component, wherein an engine computer is operatively connected to the client computer and to the remote computer, the engine computer configured to accommodate a remote connection (RC) client, the remote computer configured to accommodate a RC server, and wherein the RC client and the RC server are configured to communicate with each other under a RC protocol;
upon receiving, by the input peripheral component, input data from an input device, transmitting the input data to the engine computer through a first secured end-to-end communication channel established between the input peripheral component and the engine computer, including encrypting the input data using a first communication key;
thereby enabling the engine computer to decrypt the encrypted input data using the first communication key, inject the input data to the RC client, and transmit the input data from the RC client to the RC server to be processed by the remote computer to generate output data; and further receive the output data by the RC client from the RC server, transmit the output data from the engine computer to the output peripheral component through a second secured end-to-end communication channel established therebetween by encrypting the output data using a second communication key; and
upon receiving, by the output peripheral component, the encrypted output data from the engine computer, decrypting the encrypted output data into the output data which is rendered at an output device.

8. The computerized method according to claim 7, wherein the client computer works in a secure mode, and wherein the client computer is configured to switch between the secure mode and an open mode upon a switching condition being met.

9. The computerized method according to claim 8, wherein the switching condition is selected from a group comprising: automatic switch per predetermined time interval, and manual switch by a user.

10. The computerized method according to claim 8, further comprising, in response to the client computer switching from the secure mode to the open mode, upon receiving, by the input peripheral component, input data from an input device, transmit the input data to a processor of the client computer to be processed to generate output data, and transmit the output data by the processor to the output peripheral component for rendering at the output device.

11. The computerized method according to claim 8, wherein the input peripheral component further comprises a demultiplexer configured to enable the switching between the secure mode and the open mode.

12. The computerized method according to claim 7, wherein the first and second secured end-to-end communication channel are each established by performing a two-way authentication, and creating a communication key usable for encryption.

13. The computerized method according to claim 7, wherein the input peripheral component is a secure keyboard component configured to encrypt keystroke data received from a keyboard, and the output peripheral component is a secure display component configured to decrypt encrypted output data received from the engine computer to render for display at a display device.

14. A computerized method of secure communication between a client computer and a remote computer, the method comprising:
providing a client computer configured to communicate with a remote computer, the client computer including at least an input peripheral component and an output peripheral component;
providing an engine computer operatively connected to the client computer and to the remote computer, the engine computer configured to accommodate a remote connection (RC) client, the remote computer configured to accommodate a RC server, and wherein the RC client and the RC server are configured to communicate with each other using a RC protocol;
upon receiving, by the input peripheral component, input data from an input device, transmitting the input data to the engine computer through a first secured end-to-end communication channel established between the input peripheral component and the engine computer, including encrypting the input data using a first communication key;
decrypting, by the engine computer, the encrypted input data using the first communication key, injecting the input data to the RC client, and transmitting the input data from the RC client to the RC server to be processed by the remote computer to generate output data; and
receiving, by the RC client of the engine computer, the output data from the RC server, transmitting the output data from the engine computer to the output peripheral component through a second secured end-to-end communication channel established therebetween by encrypting the output data using a second communication key; and
receiving, by the output peripheral component, the encrypted output data from the engine computer, and decrypting the encrypted output data into the output data which is rendered at an output device.

15. A computerized method of secure communication between a client computer and a remote computer, the method comprising:
providing a client computer configured to communicate with a remote computer, the client computer including at least an input peripheral component and an output peripheral component, wherein the output peripheral component is configured to accommodate a remote connection (RC) client, the remote computer is configured to accommodate a RC server, and wherein the RC client and the RC server are configured to communicate with each other using a RC protocol;
upon receiving, by the input peripheral component, input data from an input device, transmitting the input data to the output peripheral component through a secured end-to-end communication channel established between the input peripheral component and the output peripheral component including encrypting the input data using a communication key;
upon receiving, by the output peripheral component, the encrypted input data, decrypting, using the communication key to decrypt the encrypted input data into the input data, injecting the input data into the RC client, and transmitting the input data is by the RC client to the RC server to be processed by the remote computer to generate output data; and
receiving the generated output data by the RC client from the RC server, and rendering the output data at an output device.

16. The computerized method according to claim 15, wherein the RC protocol is Virtual desktop infrastructure (VDI) protocol or a Remote Desktop Protocol (RDP).

17. The computerized method according to claim 15, wherein the RC client and the RC server communicate with each other via a virtual private network (VPN) that is set up between an operating system of the client computer and the remote computer.

18. The computerized method according to claim 15, wherein the client computer works in a secure mode, and wherein the client computer is configured to switch between the secure mode and an open mode upon a switching condition being met.

19. The computerized method according to claim 18, wherein the switching condition is selected from a group comprising: automatic switch per predetermined periodicity, and manual switch per user's request.

20. The computerized method according to claim 18, further comprising, in response to the client computer switching from the secure mode to the open mode, upon receiving, by the input peripheral component, input data from an input device, transmit the input data to a processor of the client computer to be processed to generate output data, and transmit the output data by the processor to the output peripheral component for rendering at the output device.

21. The computerized method according to claim 18, wherein the input peripheral component further comprises a demultiplexer configured to enable the switching between the secure mode and the open mode.

22. The computerized method according to claim 15, wherein a virtual private network (VPN) concentrator is operatively connected to the client computer and the remote computer, and the input data is transmitted from the RC client to the RC server under the RC protocol via a VPN that is set up between an operating system of the client computer and the VPN concentrator, and wherein the input data is further forwarded from the VPN concentrator to the RC server.

23. The computerized method according to claim 15, wherein a virtual private network (VPN) decoupler is operatively connected to the client computer and the remote computer, and the input data is transmitted from the RC client to the RC server under the RC protocol via a first VPN that is set up directly between the output peripheral component of the client computer and the VPN decoupler, and subsequently via a second VPN that is set up between the VPN decoupler and the remote computer.

24. An engine computer operatively connected to a client computer and to a remote computer and configured to enable secure communication between the client computer and the remote computer, the engine computer comprising a processor and memory unit (PMU) configured to:
upon receiving encrypted input data from the client computer, decrypt the encrypted input data into input data, injecting the input data to a remote connection (RC) client comprised in the PMU, and transmit by the RC client to a RC server accommodated in the remote computer, the input data to be processed by the remote computer to generate output data, wherein the RC client and the RC server are configured to communicate with each other under a RC protocol, and wherein the client computer includes at least an input peripheral component and an output peripheral component, and wherein the encrypted input data is generated based on the input data received by the input peripheral component from an input device, and transmitted from the input peripheral component to the engine computer through a first secured end-to-end communication channel established there between by encrypting the input data using a first communication key; and
upon receiving, by the RC client from the RC server, the output data, transmit the output data from the engine computer to the output peripheral component through a second secured end-to-end communication channel established there between including encrypting the output data using a second communication key; wherein upon being received by the output peripheral component, the encrypted output data is decrypted into the output data which is rendered at an output device.

25. The engine computer according to claim 24, wherein the RC protocol is Virtual desktop infrastructure (VDI) protocol or a Remote Desktop Protocol (RDP).

26. The engine computer according to claim 24, wherein the engine computer is integrated as a part of the remote computer.

27. The engine computer according to claim 24, wherein the first and second secured end-to-end communication channel are each established by performing a two-way authentication, and creating a communication key usable for encryption.

28. The engine computer according to claim 24, wherein the first and second secured end-to-end communication channels are each encapsulated in a virtual private network (VPN) which is set up between an operating system of the client computer and the engine computer.

29. The engine computer according to claim 24, wherein the RC client and the RC server terminal communicate with each other through a virtual private network (VPN).

30. A client computer configured to securely communicate with a remote computer, the client computer comprising:
an input peripheral component comprising a processor and memory unit (PMU) configured to:
receive input data from an input device, transmit the input data to an engine computer through a first secured end-to-end communication channel established between the input peripheral component and the engine computer, including encrypting the input data using a first communication key, wherein an engine computer is operatively connected to the client computer and to the remote computer, the engine computer configured to accommodate a remote connection (RC) client, the remote computer configured to accommodate a RC server, and wherein the RC client and the RC server are configured to communicate with each other under a RC protocol;
thereby enabling the engine computer to decrypt the encrypted input data using the first communication key, inject the input data to the RC client, and transmit the input data from the RC client to the RC server to be processed by the remote computer to generate output data; and further receive the output data by the RC client from the RC server, transmit the output data from the engine computer to the output peripheral component through a second secured end-to-end communication channel established therebetween by encrypting the output data using a second communication key; and
an output peripheral component comprising a processor and memory unit (PMU) configured to:
receive the encrypted output data from the engine computer, and decrypt the encrypted output data into the output data which is rendered at an output device.

31. The client computer according to claim 30, wherein the client computer works in a secure mode, and wherein the client computer is configured to switch between the secure mode and an open mode upon a switching condition being met.

32. The client computer according to claim 31, wherein the switching condition is selected from a group comprising: automatic switch per predetermined periodicity, and manual switch per user's request.

33. The client computer according to claim 31, wherein in response to the client computer switching from the secure mode to the open mode, upon receiving input data from an input device, the input peripheral component is further configured to transmit the input data to a processor of the client computer to be processed to generate output data, and the output peripheral component is further configured to receive the output data from the processor and render the output data at the output device.

34. The client computer according to claim 31, wherein the input peripheral component further comprises a demultiplexer configured to enable the switching between the secure mode and the open mode.

35. The client computer according to claim 30, wherein the first and second secured end-to-end communication channel are each established by performing a two-way authentication, and creating a communication key usable for encryption.

36. The client computer according to claim 30, wherein the input peripheral component is a secure keyboard unit configured to encrypt keystroke data received from a keyboard, and the output peripheral component is a secure display unit configured to decrypt encrypted display data received from the engine computer.

37. A computerized system of secure communication between a client computer and a remote computer, the system comprising:
a client computer configured to communicate with a remote computer; and
an engine computer operatively connected to the client computer and to the remote computer, the engine computer configured to accommodate a remote connection (RC) client, the remote computer configured to accommodate a RC server, and wherein the RC client and the RC server are configured to communicate with each other under a RC protocol;
wherein the client computer comprises at least an input peripheral component and an output peripheral component, and the input peripheral component is configured to:
upon receiving input data from an input device, transmit the input data to the engine computer through a first secured end-to-end communication channel established between the input peripheral component and the engine computer by encrypting the input data using a first communication key;
wherein the engine computer is configured to:
decrypt the encrypted input data using the first communication key, inject the input data to the RC client, and transmit the input data from the RC client to the RC server to be processed by the remote computer to generate output data; and
receive, by the RC client, the output data from the RC server, transmit the output data from the engine computer to the output peripheral component through a second secured end-to-end communication channel established therebetween by encrypting the output data using a second communication key; and
wherein the output peripheral component is configured to receive the encrypted output data from the engine computer, and decrypt the encrypted output data into the output data which is rendered at an output device.

38. A client computer configured to securely communicate with a remote computer, the client computer comprising:
an input peripheral component and an output peripheral component, wherein the output peripheral component is configured to accommodate a remote connection (RC) client, the remote computer is configured to accommodate a RC server, and wherein the RC client and the RC server are configured to communicate with each other using a RC protocol;
wherein the input peripheral component comprises a processor and memory circuitry (PMC) configured to:
upon receiving input data from an input device, transmit the input data to the output peripheral component through a secured end-to-end communication channel established between the input peripheral component and the output peripheral component by encrypting the input data using a communication key;
wherein the output peripheral component comprises a processor and memory circuitry (PMC) configured to:
upon receiving the encrypted input data, decrypt the encrypted input data into the input data using the communication key, inject the input data into the RC client, and transmit the input data by the RC client to the RC server to be processed by the remote computer to generate output data; and
receive the generated output data by the RC client from the RC server, and render the output data at an output device.

39. The client computer according to claim 38, wherein the RC protocol is Virtual desktop infrastructure (VDI) protocol or a Remote Desktop Protocol (RDP).

40. The client computer according to claim 38, wherein the RC client and the RC server communicate with each other through a virtual private network (VPN) that is set up between an operating system of the client computer and the remote computer.

41. The client computer according to claim 38, wherein the client computer works in a secure mode, and wherein the client computer is configured to switch between the secure mode and an open mode upon a switching condition being met.

42. The client computer according to claim 41, wherein the switching condition is selected from a group comprising: automatic switch per predetermined time interval, and manual switch by a user.

43. The client computer according to claim 41, wherein, in response to the client computer switching from the secure mode to the open mode, the input peripheral component is further configured to, upon receiving input data from an input device, transmit the input data to a processor of the client computer to be processed to generate output data, and transmit the output data by the processor to the output peripheral component for rendering at the output device.

44. The client computer according to claim 41, wherein the input peripheral component further comprises a demultiplexer configured to enable the switching between the secure mode and the open mode.

45. The client computer according to claim 38, wherein a virtual private network (VPN) concentrator is operatively connected to the client computer and the remote computer, and the input data is transmitted from the RC client to the RC server under the RC protocol via a VPN that is set up between an operating system of the client computer and the VPN concentrator, and wherein the input data is further forwarded from the VPN concentrator to the RC server.

46. The client computer according to claim 38, wherein a virtual private network (VPN) decoupler is operatively connected to the client computer and the remote computer, and the input data is transmitted from the RC client to the RC server under the RC protocol via a first VPN that is set up directly between the output peripheral component of the client computer and the VPN decoupler, and subsequently via a second VPN that is set up between the VPN decoupler and the remote computer.

47. A non-transitory computer readable storage medium tangibly embodying a program of instructions that, when executed by a computer, cause the computer to perform method steps of any of claims 1-6.

48. A non-transitory computer readable storage medium tangibly embodying a program of instructions that, when executed by a computer, cause the computer to perform method steps of any of claims 7-13.

49. A non-transitory computer readable storage medium tangibly embodying a program of instructions that, when executed by a computer, cause the computer to perform method steps of claim 14.

50. A non-transitory computer readable storage medium tangibly embodying a program of instructions that, when executed by a computer, cause the computer to perform method steps of any of claims 15-23.
